(19) United States
(12) Patent Application Publication
(10) Pub. No.: US 2023/0394419 A1
(43) Pub. Date: Dec. 7, 2023

(54) NETWORK TRACKING OF TRUCKLOADS AND SHIPMENTS

(71) Applicant: FourKites, Inc., Chicago, IL (US)

(72) Inventors: Mathew Elenjickal, Chicago, IL (US); Jason Eversole, Chicago, IL (US); Courtland Halbrook, Chicago, IL (US); Jyoti Prakash Mishra, Chicago, IL (US); Karthik Arvind Kumar, Chicago, IL (US); Karthikeyan Somanathan, Chicago, IL (US); Thamizh Pandian, Chicago, IL (US); Sathish Kuppuswamy, Chicago, IL (US); Kirubakaran Kathirvel, Chicago, IL (US); Hemavathi JN, Chicago, IL (US)

(21) Appl. No.: 18/204,446

(22) Filed: Jun. 1, 2023

Related U.S. Application Data
(60) Provisional application No. 63/348,372, filed on Jun. 2, 2022.

(51) Int. Cl. G06Q 10/0833

(52) U.S. Cl. CPC G06Q 10/0833

(57) ABSTRACT

Disclosed are systems, apparatuses, methods, and computer readable medium, and circuits for tracking shipment services. A method includes: obtaining, from a mobile computing device, a shipment information associated with a booking of a load and asset information corresponding to a physical asset associated with transport of the load; identifying one or more sources of location data for the physical asset based on the asset information; and generating tracking information for the load by associating the one or more sources of location data for the physical asset with the shipment information associated with the booking of the load.

### CROSS-REFERENCE TO RELATED APPLICATIONS

This application claims the benefit of priority to U.S. provisional application No. 63/348,372, filed on Jun. 2, 2022, entitled NETWORK TRACKING OF TRUCKLOADS AND SHIPMENTS, which is expressly incorporated by reference herein in its entirety.

### TECHNICAL FIELD

The present disclosure generally relates to tracking management systems. In some examples, aspects of the present disclosure are related to a predictive tracking management system.

### BACKGROUND

Shippers who import from various suppliers often use pre-defined commercial terms or International Commercial Terms (Incoterms) that instruct the suppliers to make carriage bookings. Unfortunately, in many cases, when a carriage booking is made, the shipper may not have visibility into the shipment or may have partial or incomplete visibility into the shipment. For example, in many cases, the supplier may not provide the booking data to the shipper after making a carriage booking. Without the booking data, the shipper may lack at least some visibility into the shipment. Such incomplete or lack of visibility into the shipment may cause gaps or inaccuracies in the supply chain visibility and/or limit or complicate the shipper's ability to track and/or process certain aspects of the shipment and provide customers accurate and/or detailed tracking and visibility of the shipment. Moreover, these factors are generally not under the control of the shipper and, as previously explained, may negatively affect the shipper's ability to accurately and/or consistently track shipments and/or provide visibility information.

### SUMMARY

In some examples, systems and techniques are described for predicting delays in carrier shipping services. The systems and techniques can visibility and identification of issues in potential shipments in carrier shipping services.

According to at least one example, a method is provided for tracking shipments (use preamble). The method includes: obtaining, from a mobile computing device, a shipment information associated with a booking of a load and asset information corresponding to a physical asset associated with transport of the load; identifying one or more sources of location data for the physical asset based on the asset information; and generating tracking information for the load by associating the one or more sources of location data for the physical asset with the shipment information associated with the booking of the load.

In another example, an apparatus for tracking shipments is provided that includes at least one memory and at least one processor coupled to the at least one memory. The at least one processor is configured to: obtain, from a mobile computing device, a shipment information associated with a booking of a load and asset information corresponding to a physical asset associated with transport of the load; identify one or more sources of location data for the physical asset based on the asset information; and generate tracking information for the load by associating the one or more sources of location data for the physical asset with the shipment information associated with the booking of the load.

In another example, a non-transitory computer-readable medium is provided that has stored thereon instructions that, when executed by one or more processors, cause the one or more processors to: obtain, from a mobile computing device, a shipment information associated with a booking of a load and asset information corresponding to a physical asset associated with transport of the load; identify one or more sources of location data for the physical asset based on the asset information; and generate tracking information for the load by associating the one or more sources of location data for the physical asset with the shipment information associated with the booking of the load.

In another example, an apparatus for tracking shipments is provided. The apparatus includes: means for obtaining, from a mobile computing device, shipment information associated with a booking of a load and asset information corresponding to a physical asset associated with transport of the load; means for identifying one or more sources of location data for the physical asset based on the asset information; and means for generating tracking information for the load by associating the one or more sources of location data for the physical asset with the shipment information associated with the booking of the load.

In some aspects, one or more of the apparatuses described herein is, is part of, and/or includes a mobile device (e.g., a mobile telephone and/or mobile handset and/or so-called “smartphone” or other mobile device), an extended reality (XR) device (e.g., a virtual reality (VR) device, an augmented reality (AR) device, or a mixed reality (MR) device), a head-mounted device (HMD) device, a vehicle or a computing system, device, or component of a vehicle, a wearable device (e.g., a network-connected watch or other wearable device), a wireless communication device, a camera, a personal computer, a laptop computer, a server computer, another device, or a combination thereof In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

In order to describe the manner in which the various advantages and features of the disclosure can be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is conceptual illustration of an example shipment management system, in accordance with some aspects of the disclosure;

FIG. 2 is a block diagram illustrating an example shipment management system, in accordance with some aspects of the disclosure;

FIG. 3 is a sequence diagram illustrating operation of the shipment management system, in accordance with some aspects of the disclosure;

FIGS. 4A-4G are conceptual illustrations of an application that an operator of a carrier vehicle may interact with to provide information to the shipment management system, in accordance with some aspects of the disclosure;

FIG. 5 is a flow diagram of a method for a predictive tracking management system, in accordance with some examples;

FIG. 6 illustrates an example computing device architecture, in accordance with some examples of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously explained, shippers who import from various suppliers often use pre-defined commercial terms or International Commercial Terms (Incoterms) that instruct the suppliers to make carriage bookings. Unfortunately, in many cases, when a carriage booking is made, the shipper may not have visibility into the shipment or may have partial or incomplete visibility into the shipment. For example, in many cases, the supplier may not provide the booking data to the shipper after making a carriage booking. Moreover, generally, the process of generating a shipment record (also referred to as a shipment or order herein) in the shipper's system is mostly or entirely manual, which is not only expensive and burdensome but may also delay the shipment and/or delay, prevent, or limit certain shipment-related data and features, such as shipment tracking/visibility, shipment data processing, shipment operations, certain workflows, etc.

To illustrate, without a shipment record or even booking data, the shipper may lack at least some visibility into the shipment and may not be able to track the shipment (or certain aspects of the shipment) end-to-end and/or point-to-point. In some cases, such incomplete or lack of visibility into the shipment may cause gaps or inaccuracies in the supply chain visibility and/or flow/operations, may limit or complicate the shipper's ability to track and/or process certain aspects of the shipment and provide customers accurate and/or detailed tracking and visibility of the shipment, etc. Moreover, these factors are generally not under the control of the shipper and, as previously explained, may negatively affect the shipper's ability to accurately and/or consistently track or process shipments and/or provide shipment visibility information.

For example, a tracking gap in brokered freight may be seen in the observation that 20-30% (or greater) of truckloads (TLs) in North America do not currently have asset information and/or are not currently tracked or trackable. Many currently untracked TLs are brokered loads, in which a shipper contracts with a Managing Carrier for transportation of a given load—the Managing Carrier in turn contracts with an Operating Carrier to actually transport the load. In such scenarios, shippers often lack information, or even awareness, of the Operating Carrier (e.g., the carrier whose truck actually hauls the load). As a result, these loads may go untracked, with the shipper lacking information regarding the progress of the load until it is ultimately delivered to its final destination.

In some cases, a shipper may be informed of the identity of the Operating Carrier responsible for hauling the shipper's load (e.g., the Managing Carrier may inform the shipper of the identity of the Operating Carrier that the Managing Carrier has contracted with). However, even if the shipper has identity information of an Operating Carrier, such information may be inadequate or insufficient for the shipper to track the progress of the load or otherwise gain visibility into the shipment.

Described herein are systems and techniques for improved network tracking of TLs, including brokered loads.

In one illustrative example, a network tracking system capable of registering and tracking one or more TLs associated with a given shipper may be implemented based on capturing asset information before a driver (e.g., a truck driver responsible for hauling a load for the given shipper) checks out or otherwise departs from the corresponding pickup location (e.g., a shipping facility). As will be described in greater depth below, the systems and techniques disclosed herein may be used to ensure that all loads are covered and are associated with adequate or sufficient information to be tracked en route to their destination. In some embodiments, the presently disclosed network tracking system may provide a localized tracking safety net, wherein drivers entering and/or exiting a pickup location are prompted to quickly confirm their load details, thereby ensuring a higher level of visibility and/or compliance throughout the network.

The presently disclosed network tracking system may provide stability and scalability across a shipper's network. For example, a shipper's supply chain may benefit from the enablement of true 100% tracking across the network, based on providing a localized checkpoint for tracking validation at each egress point (e.g., pickup location and/or drop-off location) within the shipper's network. In some aspects, the amount of check calls experienced by drivers may be reduced, while simultaneously improving the overall tracking quality that is achieved while drivers are en route with loads. In some examples, the systems and techniques may be used to provide lightweight and highly configurable integrations, such that the systems and techniques may be easily deployed into various existing shipper networks.

In one illustrative example, the presently disclosed network tracking system may be implemented based on capturing one or more of the U.S. Department of Transportation (USDOT) identifier (e.g., a USDOT number) of an operating carrier, the particular truck identifier associated with a given load, and/or the particular trailer identifier associated with the given load. Some, or all, of this information may be captured or obtained from the truck driver. In some cases, the asset information (e.g., the truck identifier and/or the trailer identifier) can be detected on entry and/or exit based on the configuration. Based on the asset information, a determination may be made as to whether the operating carrier already exists within the network.

If the operating carrier is not already on the network (e.g., does not already exist within the network), then an automatic invitation may be generated to join the shipper's network, an automatic registration process to register with the shipper's network may be triggered, etc. This enables tracking of all future loads for the operating carrier on the shipper's network.

If the operating carrier exists within the network, but is not currently connected to the network, then the connection issue may be remediated to connect the operating carrier to the network before proceeding.

In some examples, if the operating carrier is already connected to the network, then the truck identifier and the trailer identifier (e.g., obtained from the truck driver or by various capturing devices such as a camera, etc.) may be added to or otherwise associated with the particular load that is being hauled. Based on the association between the particular load and the captured truck identifier and/or trailer identifier, the presently disclosed tracking service may track the load while it is enroute to its destination.

In some aspects, the asset information is uploaded in a response to a determination that the load is not currently associated with any asset information (or the load is associated with partial/incomplete asset information). In case of a conflict, the information already available or shared by the carrier may be treated with preference. In some embodiments, the systems and techniques may include more robust tie-breaking capabilities to ensure that the proper information is selected to achieve the best outcome out of all available information.

In another aspect, the disclosure includes a method comprising: obtaining, from a mobile computing device, a shipment information associated with a booking of a load and asset information corresponding to a physical asset associated with transport of the load; identifying one or more sources of location data for the physical asset based on the asset information; and generating tracking information for the load by associating the one or more sources of location data for the physical asset with the shipment information associated with the booking of the load. Thus, in some aspects, it is the QR code or other information may function to associate the asset information and the location data for the physical asset.

Disclosed is a shipment tracking system and methods for connecting an operator (e.g., a driver) of a carrier vehicle (e.g., a tractor-trailer), to a shipping yard (e.g., shipping facility) and allows the driver to exchange information with the facility such that the operator's journey through the facility, from check-in to check-out, may be smooth and seamless. Aspects of the disclosure may include what is referred to herein as a tracking module, among others. The tracking module may be used to perform tracking of a shipment, from start to finish (e.g., end-to-end tracking from the origination location to the destination location). Using the shipment tracking system and/or the tracking module, a driver may share one or more of his/her carrier identifiers (e.g., a U.S. Department of Transport (USDOT) number or other identifier), truck number or identifier, and/or trailer number or identifier. The information obtained from the driver may be associated with the shipment (e.g., a load) being hauled by the operator. For example, the information obtained from the operator may be associated with a load identifier, a shipment reference identifier, or other load identifier, etc. In some aspects, if a driver provides a carrier identifier associated with a carrier that is not connected to or registered with the shipment tracking system (e.g., which may occur particularly with brokered loads), the carrier may be contacted through the shipment tracking system for onboarding to the network. Once the carrier is onboarded, end-to-end tracking may be performed.

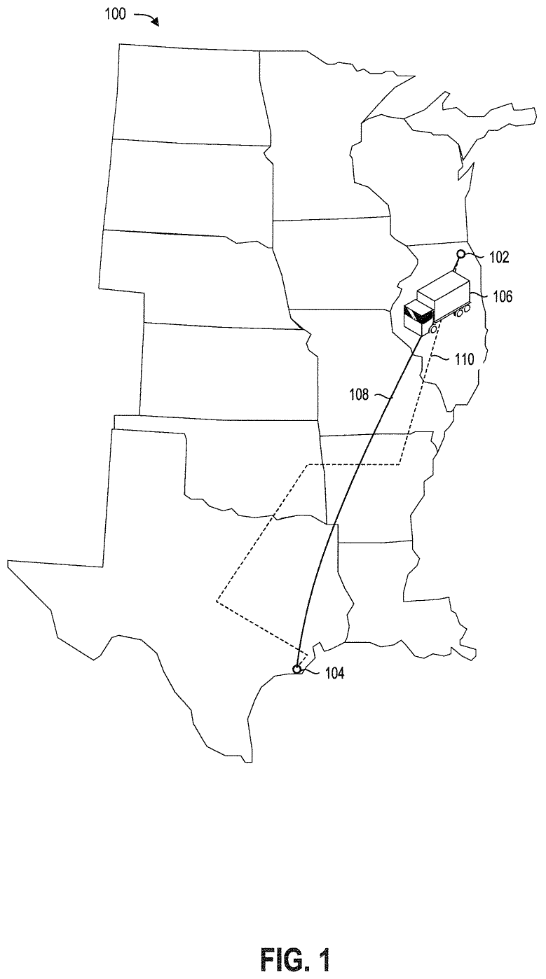

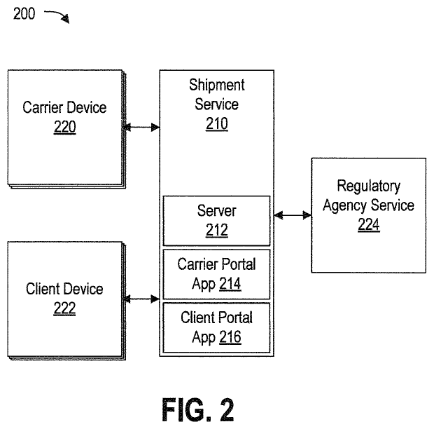

Drivers may provide asset information (e.g., one or more of the DOT identifiers, truck identifier, trailer identifier, shipment reference identifier, etc.) at the time of departure from a shipping facility. For example, a unique quick response (QR) code may be generated for each shipper's facility. The unique QR code for the shipper's facility may be placed in an area where drivers frequent (e.g., at a shipping lot's exit gate(s)). Example QR codes and associated driver prompts and interactions are depicted below in FIGS. 1 and 2:

FIG. 1 is conceptual illustration of an example shipment, in accordance with some aspects of the disclosure. In some aspects, an originator of a load (e.g., a shipment) contracts with a consigning party, or a carrier service, to transport the load from an originating location 102 to a destination location 104. However, the carrier service may contract out the consignment of the load to a third-party service 106. In some cases, the third-party service 106 can be a different carrier service or may be individuals having a load transportation vehicle, such as a tractor-trailer.

In some cases, when a carrier separately engages the third-party service 106 to handle the shipment of the load, information pertaining to the shipment of the load may be unavailable. For example, an electronic logging device (ELD) may track a location of the load using global positioning system (GPS) and cellular networks, but because the third-party service 106 is not registered within a shipment system that is configured to track the shipment 100, the movement of the load cannot be monitored. For example, a brokered shipment (e.g., a load) may be unable to be tracked as the carrier contracts the shipment to handle the carrier's responsibilities. In some cases, the shipment may be time-sensitive and being unable to identify a location of the third-party service 106 carrying the load can lead to issues. For example, in aspect illustrated FIG. 1, the load is intended to be delivered to a port in connection with an international shipment and arrival of the load at the port is critical for various purposes. For example, if the load arrives within a specific period, the load can be directly loaded onto the ship without requiring an intermediary storage within the shipment yard. In some aspects, directly loading the shipment can increase confidence in the shipment and ensures that the shipment does not experience inadvertent delays.

In this case, the third-party service can take a direct route 108, but the direct route assumes there are no other third-party consignees. In some cases, the third-party service 106 proceeds on route 110 instead of direct route 108 due to various considerations such as weather, traffic, other priorities, additional shipments, etc. In the event that the third-party service 106 brokers the shipment, an originator of the load may have no visibility into the progress of the load. Visibility into the shipment's progress may be critical to surfacing that any remediation actions should an intervening event cause a potential delay.

FIG. 2 is a block diagram illustrating an example shipment management system 200 in accordance with some aspects of the disclosure. According to aspects of the disclosure, the shipment management system 200 comprises a shipment service 210 that is configured to engage carriers that can have at least one carrier device 220, clients 222, third-party services 224, and at least one regulatory service 226 to enable seamless end-to-end shipment tracking irrespective of the actual carrier of the shipment.

In some aspects, the shipment service 210 includes a server 212 that is configured to deliver a plurality of applications such as a carrier portal application 214 and a client portal application 216. In some aspects, the carrier portal application 214 enables a seamless registration process when a carrier or a third-party service (e.g., the third-party service 106) contracting with the carrier to retrieve a load for shipment from an origination location to a destination location.

In one illustrative aspect, the carrier portal application 214 is configured to be delivered to carrier device 220 when the operator associated with the carrier enters or exits a shipment facility (e.g., an originating location). In this case, the carrier portal application 214 can be executed by the shipment service 210 or on the carrier device 220, such as a mobile computing device of the carrier or a mobile computing device of an operator (e.g., a driver). The operator uses the carrier device 220 to enter asset information, which can include a truck identifier and a trailer identifier, and the carrier device 220 sends the asset information to the shipment service 210. In response to the asset information, the shipment service 210 can execute various functionality in the server 212 to search for information stored in a repository (not shown) or other data storage device or service to retrieve information related to the assets. In some cases, the trailer identifier can be associated with an ELD, which can be used to then be used to associate a truck with a load. For example, an operator of the carrier may be required to provide the asset information when entering a shipping origination facility, which can be used to link the load (e.g., a shipment) with the carrier.

In some aspects, the shipment service 210 can be configured to communicate with a service 226 associated with a regulatory agency to connect various information from the regulatory agency. In some cases, the ELD is required to be registered with the USDOT and may be configured to provide location and/or other tracking location information from the ELD in real-time or near real-time (e.g., delayed information). In one illustrative aspect, when the shipment service 210 receives the asset information, the server 212 may include logic to surface information from the third-party services 224 to identify the tracking information of the carrier. In this case, when the carrier enters the shipping facility to retrieve the load, the operator uses the carrier portal application 214 to enter information that can be linked to the tracking information to enable real-time or near real-time tracking information which can allow a consignor (e.g., a shipper) to monitor load transit.

The client portal application 216 may be a separate application that is provided to a client device that allows monitoring of the carrier and the load while in transit. As described above, shipment service 210 associates the ELD of the vehicle carrying the load with information in the shipment service 210, allowing the shipment service 210 to provide transit information to various clients.

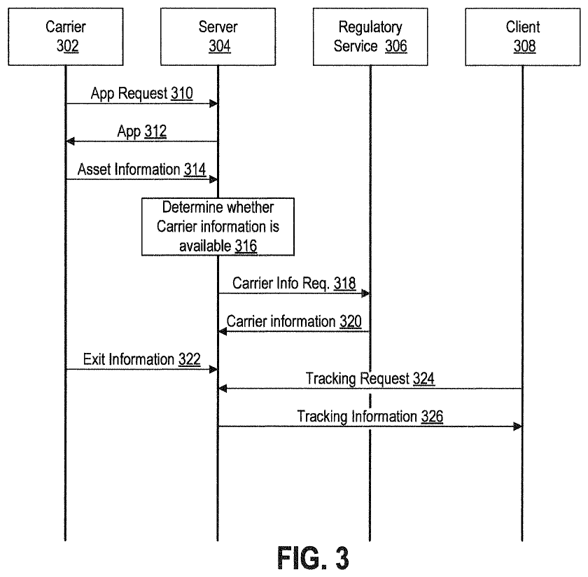

FIG. 3 is a sequence diagram 300 illustrating operation of the shipment management system, in accordance with some aspects of the disclosure. In some aspects, an origination of a shipment is requested and the sequence diagram illustrates an operation when a carrier 302 enters a facility (e.g., a shipping location) to originate shipment of a load to a destination location. As will be described below, a server 304 may use a regulatory service 306 to connect endpoint information to enable tracking of the load and a client 308 can request and receive tracking information.

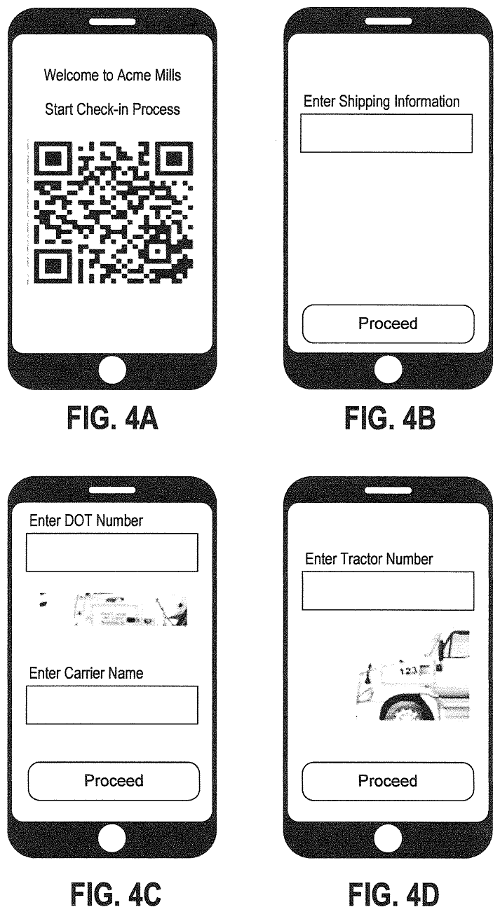

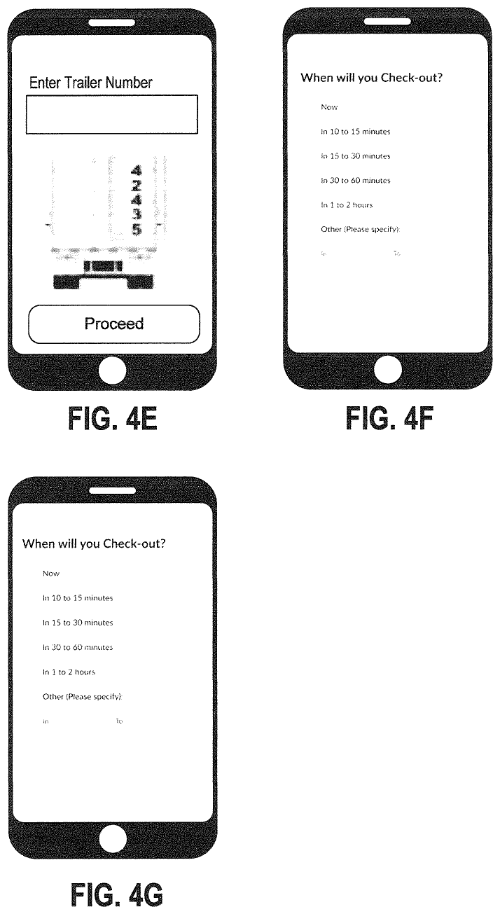

In some aspects, the carrier 302 can actively or passively connect the carrier to the shipment service. As an example, when the carrier 302 enters the facility, the carrier sends an application request 310 to request an application from a server 304 by scanning a QR code or some other link to enable interoperation with the application. In the example of a QR code, the QR code may be a link to a client-based or a server-based application that the operator interacts with to asset information associated with the shipment. For example, a QR code that an operator of the carrier 302 may scan is illustrated in FIG. 4A.

A server-based application corresponds to a server that performs the rendering of the application, and a client-based application corresponds to a client that downloads the functionality and performs the rendering of the application. As an example, a server-based application may generate and send hypertext markup language (HTML) with some JavaScript assets, and a client-based application may send a JavaScript bundle with instructions that dynamically generate HTML to render the page using, for example a virtual document object model (VDOM).

The server 304 sends the application 312 to the carrier 302 and the carrier performs the various interactions to generate an asset information 314 and transmit the asset information to the server 304. Asset information 314 includes various information to link the carrier 302 to the shipment that is being retrieved and is further illustrated with reference to FIGS. 4B to 4G. For example, the application 312 may require the operator of the carrier 302 to provide a piece of shipment information that uniquely identifies a shipment. After entering the shipment information, the application 312 may request a USDOT identifier and/or carrier name to link the shipment with the carrier. An example of entry of a USDOT identifier and/or carrier name is further illustrated with reference to FIG. 4B.

In some cases, the application 312 can also request vehicle information such as a tractor number (shown in FIG. 4C) and a trailer number (shown in FIG. 4D). In some cases, the application 312 may request information related to the carrier vehicle that is determined by a facility, such as by using cameras to capture images of the carrier vehicle and its trailer and determine information to preclude an operator of the carrier 302 from manually entering all information and prevent human mistakes. For, the application 312 may allow the operator to capture an image of physical media (e.g., a shipping notice, etc.) that includes the shipping information. After all data is input and confirmed by the operator of the carrier 302, the application 312 sends the asset information 314 (e.g., USDOT identifier, shipping information, trailer identifier, etc.) to the server 304 to associate the carrier 302 with the shipment associated with the shipment identifier.

At block 316, the server determines whether carrier information is available. For example, based on the USDOT identifier, the server may determine that the carrier is not registered with the server 304. If carrier is not registered, the server 304 may send a carrier information request 318 to a regulatory service 306 to request the carrier's information (e.g., carrier name, address, etc.). In response to the carrier information request 318, the regulatory service 306 returns the carrier information 320 to the server 304. In some cases, the server 304 can register the carrier 302 automatically with the shipment service, which the carrier can update as needed to facilitate shipments. For example, the shipment service can provide private information, such as insurance information, to the shipment service to allow the shipment service to provide relevant information to clients and reduce any friction and unnecessary delays.

If the event that carrier information is available, or after the carrier information 320 is retrieved from the regulatory service 306, the asset information is associated with the shipment based on the shipment identifier. In this case, even if the carrier 302 is a third party that is handling the shipping for a broker, the shipment information (e.g., a shipping identifier) is uniquely associated with the carrier and other asset information. For example, the shipment may be loaded onto the trailer of the carrier's vehicle, and the ELD of the trailer is associated with the trailer identifier that the operator provided.

In some cases, the carrier 302 may also be configured to provide exit information 322 to the server 304 upon exit. In some cases, the exit information can include time information, tractor identifier, trailer identifier, or other identifying information to link the entrance of the carrier vehicle and the shipment.

In some cases, a client may submit a tracking request 324 to the server 304 and receive tracking information 326 in response. The ELD uses GPS to identify the geographical position and a cellular device integral to the ELD to report location of the ELD during transit. By linking the shipment information to the carrier vehicle or asset of the carrier vehicle (e.g., the trailer), the shipment service enables real-time tracking of the shipment. Although FIG. 3 illustrate the tracking request 324 is before linking the asset information (e.g., tractor identifier, trailer identifier, etc.) to the shipment information, the tracking request 324 can also happen before to determine whether the package has been received, whether the shipment is loading (e.g., by virtue of no exit information being reported to the server 304), and/or where the shipment currently is based on the ELD.

For purposes of illustration, FIG. 3 illustrates a client-based application for purposes of clarity. However, variations of FIG. 3 can be configured. For example, the application may be a native application that is retrieved from an app store and configured to execute based on scanning the QR code. In other aspects, the facility can include one or more image sensors that are configured to capture images of carrier vehicles that enter the facility and may perform optical character recognition (OCR) on the images to identify the asset information, the carrier, and other pertinent information. As an example, a carrier enters the facility to pick up a shipment and one or more images are captured of the carrier vehicles and extract carrier information, vehicle information, or trailer information. When the operator of the carrier executes the application, the application may request information that was extracted from the one or more images. This operation can reduce friction and increase throughput of carrier vehicles. In other aspects, a carrier vehicle can include a sensor that automatically identifies the carrier upon entry, and upon exit with the load, may require the carrier to confirm their load.

The QR code is also an example and there are additional techniques that can be implemented to reduce user input time. For example, a carrier vehicle can use an ultrawide bandwidth (UWB) device for various purposes (e.g., to detect a position of the shipment within the vehicle with higher accuracy), and the UWB device may be registered with the shipment service. In such a case, the carrier vehicle may only need to enter information pertaining to the shipment. In other cases, the operator of the carrier vehicle can provide a copy of a shipping slip that includes the shipment identifier upon entry into the facility, which is scanned and converted using OCR in to text and processed for various information to facilitate user interaction.

FIGS. 4A-4G are conceptual illustrations of an application that an operator of a carrier vehicle may interact with to provide information to the shipment management system, in accordance with some aspects of the disclosure.

In one illustrative aspect, FIG. 4A illustrates an example notice 400 that an operator of the carrier may need to interact upon entry into the facility or access the facility in accordance with some aspects of the disclosure. For example, the facility may place the notice outside of a gated entry and the scanning of the gated entry is required for entry. As noted above, the image encode digital information (e.g., a QR code) and provide a link to an application that is executed by a device of the operator. Upon scanning the example notice 400 and interacting with the application, the application is executed to receive information from the operator or have the operator confirm information as described above.

FIG. 4B illustrates example image displayed by an application (e.g., application 312, etc.) for interacting with the system in accordance with some aspects of the disclosure. In one aspect, a shipping bill that the operator of a carrier vehicle possesses may include a shipping information (e.g., a shipping identifier), and the operator uses the application to enter the shipping information from the shipping bill.

FIG. 4C illustrates an example image displayed by an application for interacting with the system in accordance with some aspects of the disclosure. FIG. 4C particularly illustrates entry of a USDOT identifier, a carrier name, and guide information that guides the operator to identify information related to the USDOT identifier. In some cases, one or more of the USDOT and/or the carrier name may be optional.

FIG. 4D illustrates an example image displayed by an application for interacting with the system in accordance with some aspects of the disclosure. As shown in FIG. 4D, the application requests input of a truck identifier and also includes guide information illustrating the location of where to identify the truck identifier to facilitate input of truck information.

FIG. 4E illustrates an example image displayed by an application for interacting with the system in accordance with some aspects of the disclosure. As shown in FIG. 4E, the application requests input of a trailer identifier and also includes guide information to facilitate input of the trailer identifier.

FIG. 4F illustrates an example image displayed by an application for interacting with the system in accordance with some aspects of the disclosure. As shown in FIG. 4F, the application may include options to allow the operator to provide input related to an expected delay. In such cases, the application may reserve the asset information to prevent the asset information, and thereby tracking information, from being surfaced while still within the shipping yard.

FIG. 4G illustrates an example image displayed by an application for interacting with the system in accordance with some aspects of the disclosure. As shown in FIG. 4G, the application may allow the operator to take a break prior to exiting the facility.

In some, the application may display a confirmation screen for the operator to validate the veracity of the input information. Although a specific sequence of images (which may also be referred to as screens or views), the order of the user input can be in any order, with varying types of organization. In some cases, images may be omitted, information within the form inputs may be partially filled out as described above, or other information can be surfaced using various techniques.

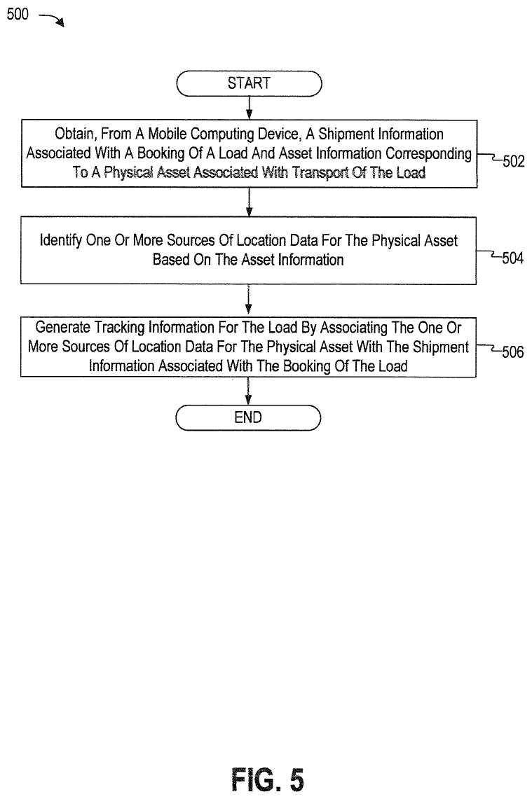

FIG. 5 is a flow diagram of a method for a shipment tracking system, in accordance with some examples. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

In some aspects, the computing system may obtain one or more of the shipment information and the asset information is obtained using an online portal. For example, the online portal presented is in response to activating a function when a carrier vehicle associated with the asset information enters a shipping location. In some cases, the activating of the function comprises receiving an image or binary data encoded into the image from the mobile computing device.

At block 502, the computing system may obtain a shipment information associated with a booking of a load and asset information corresponding to a physical asset associated with transport of the load. The asset information includes one or more of an agency (e.g., USDOT) identifier, a tractor identifier, and a trailer identifier.

In one example of block 502, the computing system may receive an at least one image or data extracted from the at least one image from an entrance detection device. The at least one image captures information identifying at least one of a carrier vehicle or the physical asset that is attached to the carrier vehicle. In this case, the shipment information may be completely or partially extracted and provided to the operator of the carrier vehicle to reduce human input errors.

At block 504, the computing system may identify one or more sources of location data for the physical asset based on the asset information. The one or more sources of location data include an ELD associated with the carrier vehicle or an ELD associated with the trailer. For example, generating the tracking information for the load comprises assigning the shipment information to the ELD associated with the carrier vehicle or the ELD associated with the trailer.

At block 506, the computing system may generate tracking information for the load by associating the one or more sources of location data for the physical asset with the shipment information associated with the booking of the load.

The computing system may receive an indication that the carrier vehicle for transporting the load has exited a shipping location with the load. After the carrier vehicle exits, the shipping information may be made available to one or more third parties.

The computing system can also query a regulatory agency for carrier information based on the asset information, for example, when the shipment service does not recognize the agency identifier. In this case, the carrier information may not correspond to an originating carrier that is provided during the booking of the load. In some cases, the computing system may register the carrier information using information provided by the regulatory agency based on the carrier information being unavailable.

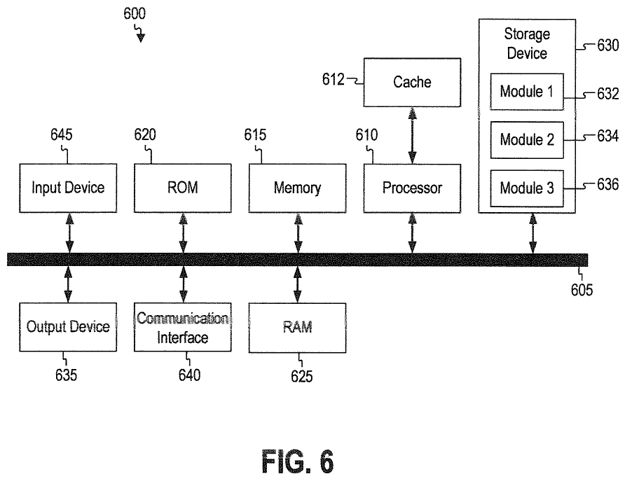

FIG. 6 is a diagram illustrating an example of a system for implementing certain aspects of the present technology. In particular, FIG. 6 illustrates an example of computing system 600, which can be for example any computing device making up an internal computing system, a remote computing system, a camera, or any component thereof in which the components of the system are in communication with each other using connection 605. In some cases, the connection 605 can be a physical connection using a bus, or a direct connection into processor 610, such as in a chipset architecture. The connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

The example computing system 600 includes at least one processor 610 (e.g., a CPU or processor unit) and connection 605 that couples various system components including system memory 615, such as ROM 620 and RAM 625 to processor 610. The computing system 600 can include a cache 612 of high-speed memory connected directly with, in close proximity to, or integrated as part of the processor 610.

The processor 610 can include any general purpose processor and a hardware service or software service, such as services 632, 634, and 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction, the computing system 600 includes an input device 645, which can represent any number of input mechanisms, such as a microphone for speech, a touch-sensitive screen for gesture or graphical input, keyboard, mouse, motion input, speech, etc. The computing system 600 can also include output device 635, which can be one or more of a number of output mechanisms. In some instances, multimodal systems can enable a user to provide multiple types of input/output to communicate with computing system 600. The computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method comprising:
obtaining, from a mobile computing device, a shipment information associated with a booking of a load and asset information corresponding to a physical asset associated with transport of the load;
identifying one or more sources of location data for the physical asset based on the asset information; and
generating tracking information for the load by associating the one or more sources of location data for the physical asset with the shipment information associated with the booking of the load.

2. The method of claim 1, wherein one or more of the shipment information and the asset information are obtained using an online portal, the online portal presented in response activating a function when a carrier vehicle associated with the asset information enters into a shipping location.

3. The method of claim 2, wherein activating the function comprises receiving an image or binary data encoded into the image from the mobile computing device.

4. The method of claim 1, further comprising receiving an at least one image or data extracted from the at least one image from an entrance detection device, wherein the at least one image captures information identifying at least one of a carrier vehicle or the physical asset that is attached to the carrier vehicle.

5. The method of claim 4, further comprising:
receiving an indication that the carrier vehicle for transporting the load has exited a shipping location with the load.

6. The method of claim 1, wherein the asset information includes one or more of an agency identifier, a tractor identifier, and a trailer identifier.

7. The method of claim 6, wherein the one or more sources of location data include an Electronic Logging Device (ELD) associated with the carrier vehicle or an ELD associated with the trailer.

8. The method of claim 7, wherein generating the tracking information for the load comprises assigning the shipment information to the ELD associated with the carrier vehicle or the ELD associated with the trailer.

9. The method of claim 1, further comprising:
querying a regulatory agency for carrier information based on the asset information, wherein the carrier information does not correspond to an originating carrier that is provided during the booking of the load.

10. The method of claim 9, further comprising:
registering the carrier information using information provided by the regulatory agency based on the carrier information being unavailable.

11. An apparatus comprising:
at least one memory; and
at least one processor coupled to at least one memory and configured to:
obtain, from a mobile computing device, a shipment information associated with a booking of a load and asset information corresponding to a physical asset associated with transport of the load;
identify one or more sources of location data for the physical asset based on the asset information; and
generate tracking information for the load by associating the one or more sources of location data for the physical asset with the shipment information associated with the booking of the load.

12. The apparatus of claim 11, wherein one or more of the shipment information and the asset information are obtained using an online portal, the online portal presented in response activating a function when a carrier vehicle associated with the asset information enters into a shipping location.

13. The apparatus of claim 12, activating the function comprises receiving an image or binary data encoded into the image from the mobile computing device.

14. The apparatus of claim 11, wherein the at least one processor is configured to:
receive an at least one image or data extracted from the at least one image from an entrance detection device, wherein the at least one image captures information identifying at least one of a carrier vehicle or the physical asset that is attached to the carrier vehicle.

15. The apparatus of claim 14, wherein the at least one processor is configured to:
receive an indication that the carrier vehicle for transporting the load has exited a shipping location with the load.

16. The apparatus of claim 11, wherein the asset information includes one or more of an agency identifier, a tractor identifier, and a trailer identifier.

17. The apparatus of claim 16, wherein the one or more sources of location data include an Electronic Logging Device (ELD) associated with the carrier vehicle or an ELD associated with the trailer.

18. The apparatus of claim 17, wherein generating the tracking information for the load comprises assigning the shipment information to the ELD associated with the carrier vehicle or the ELD associated with the trailer.

19. The apparatus of claim 11, wherein the at least one processor is configured to:
query a regulatory agency for carrier information based on the asset information, wherein the carrier information does not correspond to an originating carrier that is provided during the booking of the load.

20. The apparatus of claim 19, wherein the at least one processor is configured to:
register the carrier information using information provided by the regulatory agency based on the carrier information being unavailable.
